(19) United States
(12) Patent Application Publication
(10) Pub. No.: US 2019/0357585 A1
(43) Pub. Date: Nov. 28, 2019

(54) WRAPPING DEVICE FOR SHEET-LIKE FOOD

(71) Applicant: KAWASAKI JUKOGYO KABUSHIKI KAISHA, Kobe-shi, Hyogo (JP)

(72) Inventors: Kenji BANDO, Nishinomiya-shi (JP); Kazunori HIRATA, Yao-shi (JP)

(73) Assignee: KAWASAKI JUKOGYO KABUSHIKI KAISHA, Kobe-shi, Hyogo (JP)

(21) Appl. No.: 16/484,995

(22) PCT Filed: Feb. 6, 2018
(86) PCT No.: PCT/JP2018/004024

§ 371 Date: Aug. 9, 2019

(30) Foreign Application Priority Data
Feb. 9, 2017 (JP) 2017-022512

(51) Int. Cl. A23P 20/20; A23L 17/60; A23L 7/10

(52) U.S. Cl. CPC A23P 20/20; A23V 2002/00; A23L 7/10; A23L 17/60

(57) ABSTRACT

A wrapping device is a device configured to wrap sheet-like food around shaped food. The wrapping device includes a main body, two guide members at a given interval therebetween so as to protrude from the main body, and a control part configured to control at least one of the two guide members. The control part controls operation of the two guide members so that, in a state where the sheet-like food is placed on the two guide members and the food placed on the sheet-like food passes through between the two guide members, a part of at least one of the two guide members moves an end of the sheet-like food toward the center of the food to wrap the end of the sheet-like food around the food.

### TECHNICAL FIELD

The present disclosure relates to a wrapping device for a sheet-like food, such as dried seaweed.

### BACKGROUND ART

Conventionally, there are automatic rice ball manufacturing devices which wrap dried seaweed around a molded rice ball. For example, Patent Document 1 discloses a configuration in which dried seaweed is fed to a gap between guides and a rotary member from a dried-seaweed feeding device, a rice ball pushed out from a forming hole at the lowest position moves forward while being guided by the guides, the dried seaweed is wrapped around the rice ball to become a ship roll, and the ship roll falls on a plate from a ceiling.

### REFERENCE DOCUMENT OF CONVENTIONAL ART

### Patent Document

[Patent Document 1] JP2004-049007A

### DESCRIPTION OF THE DISCLOSURE

### Problems to be Solved by the Disclosure

However, in the device of Patent Document 1, the guides which guide the rice ball are fixed. Thus, just the rice ball falling between the guides is insufficient for wrapping the dried seaweed all around the rice ball. Such a problem is common to cases where other sheet-like foods are wrapped around a rice ball, other than the dried seaweed.

The present disclosure is made in view of the above problem, and one purpose thereof is to ensure a seaweed wrapping work for a rice ball with a simple configuration.

### SUMMARY OF THE DISCLOSURE

In order to achieve the purpose, a wrapping device for a sheet-like food according to one aspect of the present disclosure is a device configured to wrap sheet-like food around shaped food, which includes a main body, two guide members provided at a given interval therebetween so as to protrude from the main body, and a control part configured to control operation of at least one of the two guide members. The control part controls operation of the two guide members so that, in a state where the sheet-like food is placed on the two guide members and the food placed on the sheet-like food passes through between the two guide members, a part of at least one of the two guide members moves an end of the sheet-like food toward the center of the food to wrap the end of the sheet-like food around the food.

According to this configuration, by the part of at least one of the two guide members being operated to move toward the center of the food (e.g., a rice ball), the end of the sheet-like food (e.g., a dried seaweed) in the state where it passes through between the two guide members, are wrapped around the food.

The control part may control operation of the two guide members to move toward the center of the food so that the given interval is reduced.

According to this configuration, the dried seaweed is easy to be wrapped all around the food.

The food may pass through between the two guide members by the sheet-like food being placed on the two guide members, and the food placed on the sheet-like food falling between the two guide members by the own weight of the food.

According to this configuration, the dried seaweed is easy to be wrapped all around the food.

The control part may control the two guide members to move upwardly while maintaining the given interval so that the sheet-like food is placed on the two guide members, and the two guide members pass through both sides of the food disposed on the sheet-like food.

According to this configuration, the dried seaweed is easy to be wrapped all around the food.

The given interval may be slightly larger than a width of the food.

According to this configuration, the food is easy to pass through between the two guide members.

The wrapping device may further include a robot including a base, a first robotic arm coupled to the base and configured to feed the sheet-like food to a given position, and a second robotic arm coupled to the base and configured to feed a shaped food to a given position. The first robotic arm may place the sheet-like food on the two guide members. The second robotic arm may places the food on the sheet-like food, and at a position between the two guide members.

According to this configuration, feeding of a dried seaweed and a rice ball can be realized by the dual-arm type robot.

A method of wrapping sheet-like food according to another aspect of the present disclosure is a method of wrapping sheet-like food around shaped food by a wrapping device for the sheet-like food including a main body, two guide members provided at a given interval therebetween so as to protrude from the main body, and a control part configured to control at least one of the two guide members. The control part controls operation of the two guide members so that, in a state where the sheet-like food is placed on the two guide members and the food placed on the sheet-like food passes through between the two guide members, a part of at least one of the two guide members moves an end of the sheet-like food toward the center of the food to wrap the end of the sheet-like food around the food.

### Effect of the Disclosure

The present disclosure has the configuration described above and can ensure a seaweed wrapping work for the rice ball with a simple configuration.

### BRIEF DESCRIPTION OF DRAWINGS

FIG. 1 is a perspective view illustrating the entire configuration of a wrapping device for sheet-like food according to a first embodiment of the present disclosure.

FIG. 2 is a front view schematically illustrating the entire configuration of one example of a robot of FIG. 1.

FIGS. 3(A) and 3(B) are views illustrating a configuration of the wrapping device in FIG. 1.

FIG. 4 is a functional block diagram schematically illustrating a configuration of a control device.

FIG. 5 is a flowchart illustrating operation of the wrapping device.

FIGS. 6(A) to 6(E) are schematic views illustrating one example of operation of the wrapping device according to steps.

FIGS. 7(A) and 7(B) are view illustrating a configuration of a wrapping device according to a first modification.

FIGS. 8(A) to 8(E) are schematic views illustrating one example of operation of the wrapping device of FIGS. 7(A) and 7(B).

FIG. 9 is a schematic view illustrating one example of operation of a wrapping device according to a second modification.

FIGS. 10(A) to 10(E) are schematic views illustrating one example of operation of a wrapping device according to a second embodiment of the present disclosure.

### MODES FOR CARRYING OUT THE DISCLOSURE

Hereinafter, desirable embodiments will be described with reference to the drawings. Note that, in the following, the same reference characters are given to the same or corresponding components throughout the drawings to omit redundant description. Moreover, the drawings are to schematically illustrate each component for easier understandings. Further, a direction in which a pair of arms are extended is referred to as “the left-and-right direction,” a direction parallel to an axial center of a base shaft is referred to as “the up-and-down direction,” and a direction perpendicular to the left-and-right direction and the up-and-down direction is referred to as “the front-and-rear direction.”

### First Embodiment

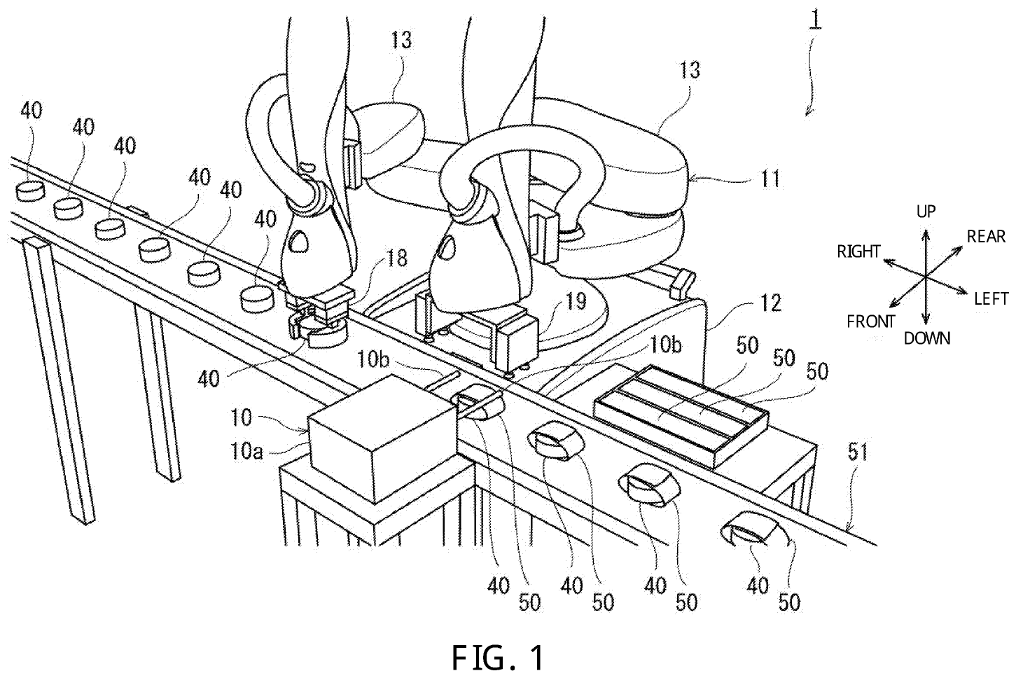

FIG. 1 is a perspective view illustrating the entire configuration of a wrapping device for sheet-like food according to a first embodiment of the present disclosure. As illustrated in FIG. 1, a wrapping device 1 is a device to wrap a sheet-like food 50 formed in a sheet shape around a molded food 40. As illustrated in FIG. 1, in this embodiment, the food 40 is cooked rice molded in a flat cylindrical shape (hereinafter, referred to as “the rice ball”). The sheet-like food 50 is dried seaweed for sushi rolls, for the rice ball, cut in a rectangular shape. In this embodiment, a case where the wrapping device 1 for the sheet-like food 50 according to the present disclosure is constituted by a device main body 10 and a robot 11 will be described. The robot 11 is a dual-arm robot having a pair of robotic arms 13 supported by a base 12. However, the wrapping device 1 for the sheet-like food 50 is not limited to the configuration with the robot 11. Note that, although this robot 11 is a horizontal articulated dual-arm robot, a vertical articulated robot may be adopted. The robot 11 can be installed within a limited space (for example, 610 mm×620 mm) equivalent to one person.

A belt conveyor 51 is disposed in front of the robot 11. In this embodiment, a workspace of the pair of robotic arms 13 is an area which covers a part of the belt conveyor 51. The belt conveyor 51 is a device which conveys a plurality of rice balls (40) with a given interval from a front right location of the robot 11 to a left location, and extends in a left-and-right direction.

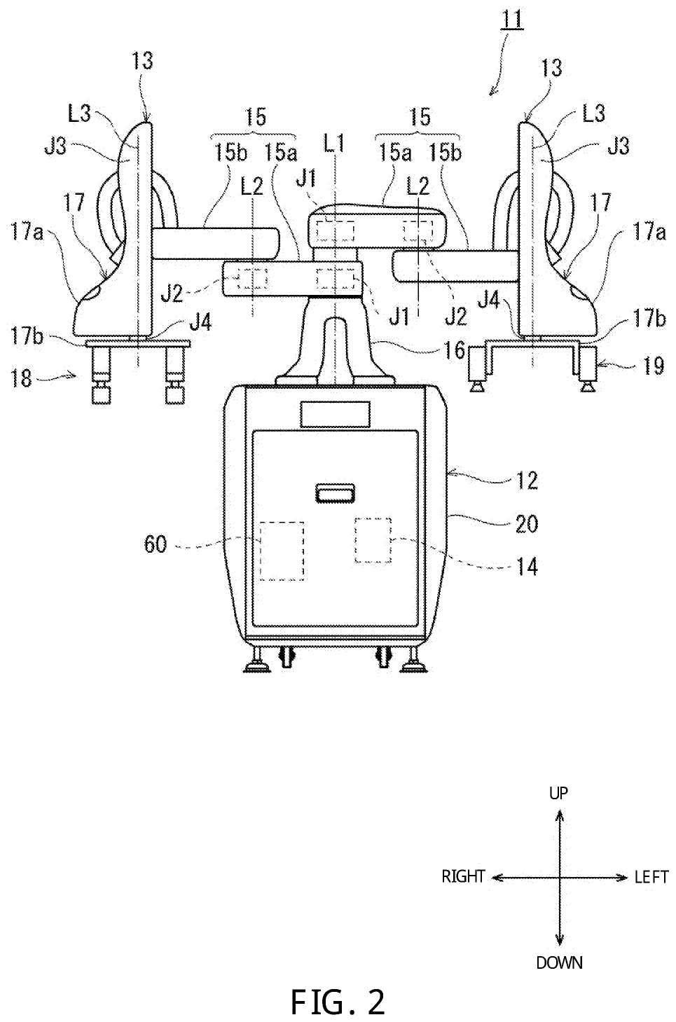

FIG. 2 is a front view schematically illustrating the entire configuration of one example of the robot of FIG. 1. As illustrated in FIG. 2, the robot 11 includes the base 12 fixed to a carrier, the pair of robotic arms (hereinafter, may simply be referred to as “the arm(s)”) 13 supported by the base 12, and a control device 14 and a vacuum generator 60 which are accommodated inside the base 12. The vacuum generator 60 is a device which generates a negative pressure at suction heads of an end effector 19 (described later), such as a vacuum pump and CONVUM®. Each arm 13 is a horizontal articulated robotic arm constructed to be movable with respect to the base 12. Each arm 13 includes an arm part 15, a wrist part 17, and the end effector 18 or 19. Note that the right arm 13 and the left arm 13 may have substantially the same structure. Moreover, the right arm 13 and the left arm 13 can operate independently or dependently.

In this example, the arm part 15 is comprised of a first link 15a and a second link 15b. The first link 15a is coupled to a base shaft 16 fixed to an upper surface of the base 12 by a rotary joint J1, and is rotatable on a rotation axis L1 passing through the axial center of the base shaft 16. The second link 15b is coupled to a tip end of the first link 15a by a rotary joint J2, and is rotatable on a rotation axis L2 defined at the tip end of the first link 15a.

The wrist part 17 is comprised of an elevating part 17a and a rotary part 17b. The elevating part 17a is coupled to a tip end of the second link 15b by a linear-motion joint J3, and is ascendable and descendable with respect to the second link 15b. The rotary part 17b is coupled to a lower end of the elevating part 17a by a rotary joint J4, and is rotatable on a rotation axis L3 defined at the lower end of the elevating part 17a.

Each of the end effectors 18 and 19 is coupled to the rotary part 17b of the wrist part 17. The end effector 18 is provided to a tip end of the right arm 13. The end effector 19 is provided to a tip end of the left arm 13. The end effector 18 has a pair of holding members, and is constructed to be holdable of the rice ball 40 placed on the conveyor 51 from both sides. The end effector 19 has a plurality of suction heads, and is configured to suck and hold the sheet-like food 50.

Each arm 13 of the above structure has joints J1-J4. The arm 13 is provided, so as to be associated with the joints J1-J4, servo motors for drive (not illustrated), and encoders (not illustrated) which detect rotational angles of the servo motors, respectively. Moreover, the rotation axes L1 of the first links 15a of the two arms 13 are located on the same straight line, and the first link 15a of one arm 13 and the first link 15a of the other arm 13 are provided with a height difference therebetween.

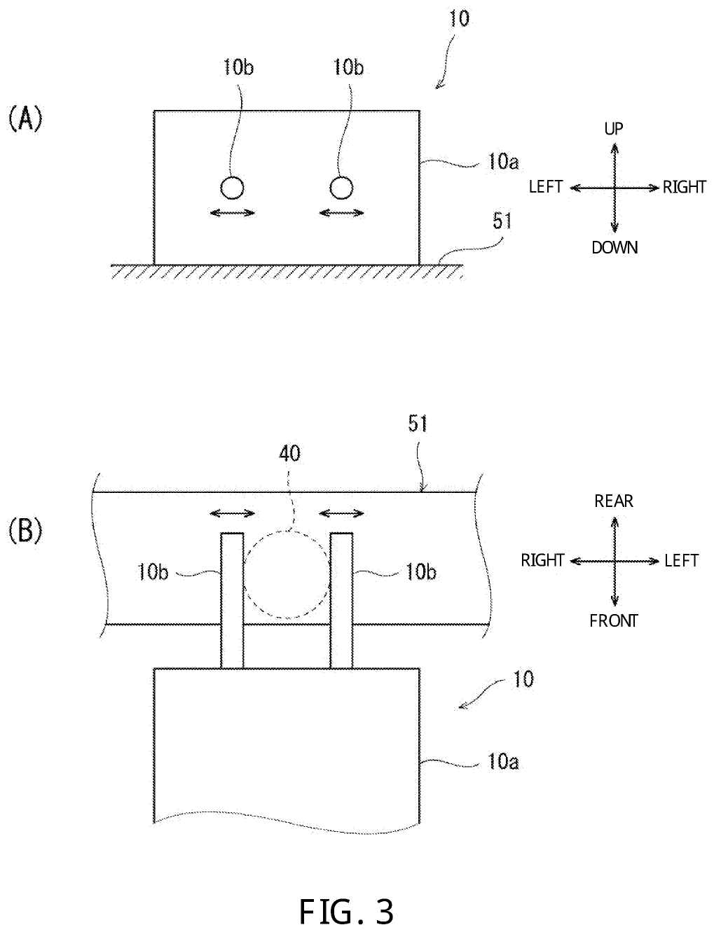

FIG. 3(A) is a front view of the wrapping device main body 10 of FIG. 1. FIG. 3(B) is a plan view of the device main body 10. As illustrated in FIG. 3, the device main body 10 is provided with a main body 10a and two guide members 10b provided so as to protrude from the main body 10a at a given interval therebetween. The two guide members 10b of this embodiment are each formed in a bar shape and are formed in the same shape. The two guide members 10b are provided in parallel to each other and at the same height, and protrude to a location above the belt conveyor 51. The given interval is slightly larger than the width of the rice ball (40). A servo motor for drive (not illustrated) which drives the two guide members 10b horizontally is built inside the main body 10a. Thus, in this embodiment, the two guide members 10b horizontally operates toward the center of the rice ball (40) by reducing the given interval. In the following, a given position of the guide member 10b before being driven is referred to as “the reference position” of the guide member 10b.

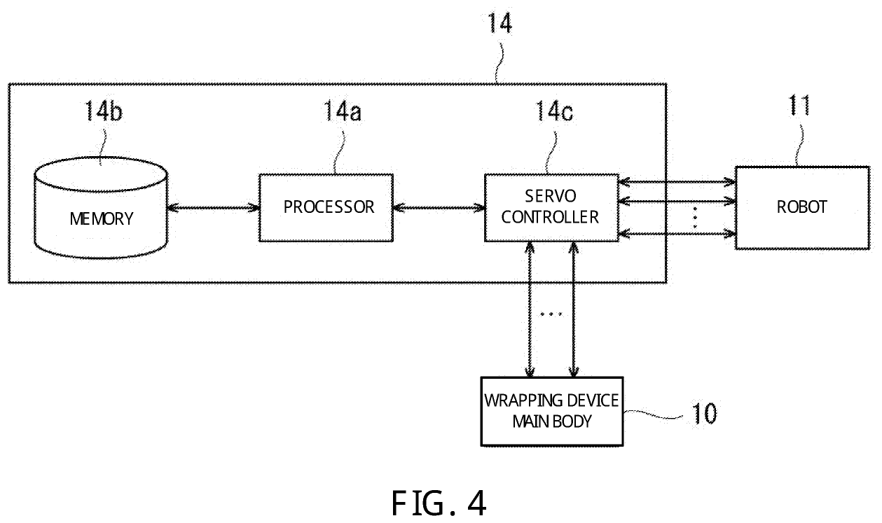

FIG. 4 is a functional block diagram schematically illustrating a configuration of the control device 14 of the robot 11 of FIG. 2. As illustrated in FIG. 4, the control device 14 includes a processor 14a, such as a CPU, a memory 14b, such as a ROM and/or a RAM, and a servo controller 14c. The control device 14 is a robot controller provided with a computer, such as a microcontroller. Note that the control device 14 may be comprised of a sole control device 14 which carries out a centralized control, or may be comprised of a plurality of control devices 14 which collaboratively carry out a distributed control.

The memory 14b stores information on a basic program as the robot controller, various fixed data, etc. The processor 14a controls various operations of the robot 11 by reading and executing software, such as the basic program stored in the memory 14b. That is, the processor 14a generates control commands for the robot 11, and outputs them to the servo controller 14c. The servo controller 14c is configured to control the drive of the servo motors corresponding to the joints J1-J4 etc. of each arm 13 of the robot 11 based on the control commands generated by the processor 14a. In this embodiment, it is configured so that the molded rice ball (40) is fed to a given position by the right arm 13 and the sheet-like food 50 is fed to a given position by the left arm 13. Moreover, the servo controller 14c is configured to control the servo motor which drives the two guide members 10b of the device main body 10, based on the control command generated by the processor 14a.

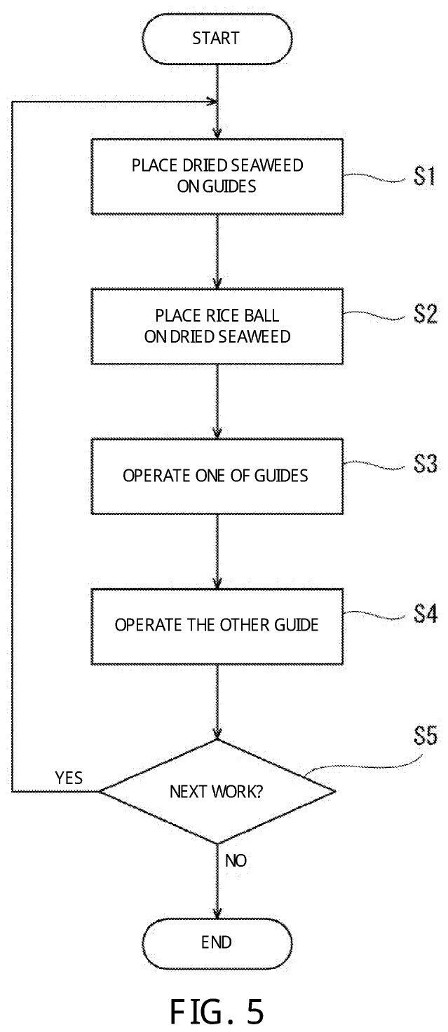

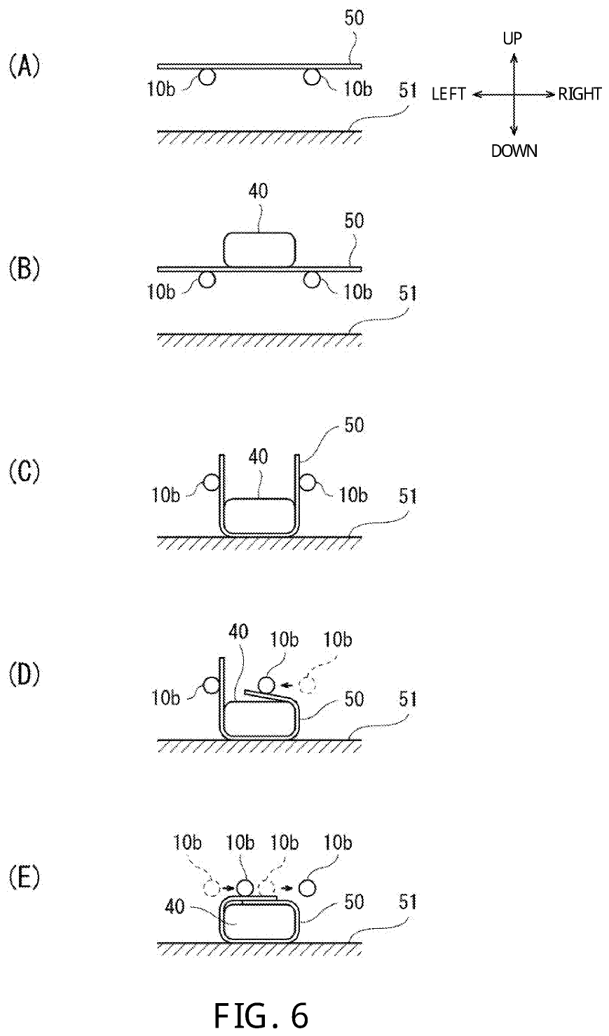

Next, operation of the wrapping device 1 is described. FIG. 5 is a flowchart illustrating the operation of the wrapping device 1. FIGS. 6(A) to 6(E) are schematic views, according to respective steps of FIG. 5, illustrating one example of operation of the wrapping device 1. Note that operation of the belt conveyor 51 is suspended during the operation of the wrapping device 1.

First, the control device 14 controls the operation of the left arm 13 so that the dried seaweed (50) is sucked and held by the end effector 19, and as illustrated in FIG. 6(A), the dried seaweed (50) is placed on the two guide members 10b (Step S1 in FIG. 5).

Next, the control device 14 controls the operation of the right arm 13 so that the rice ball (40) is held by the end effector 18, and as illustrated in FIG. 6(B), the rice ball (40) is placed on the dried seaweed (50) and at a position between the two guide members 10b (Step S2 in FIG. 5). Since the given interval of the two guide members 10b is slightly larger than the width of the rice ball (40), the rice ball (40) placed on the dried seaweed (50) passes through between the two guide members 10b, and falls on the belt conveyor 51 by its own weight, as illustrated in FIG. 6(C).

Next, the control device 14 controls operation of one of the two guide members 10b (Step S3 in FIG. 5). As illustrated in FIG. 6(D), the right guide member 10b horizontally moves toward the center of the rice ball (40) from the reference position by a given width. Thus, a part of the dried seaweed (50) on the right side which is in contact with the right guide member 10b is wrapped around the rice ball (40).

Next, the control device 14 controls operation of the other guide member 10b (Step S4 in FIG. 5). As illustrated in FIG. 6(E), the left guide member 10b horizontally moves toward the center of the rice ball (40) from the reference position by a given width. Thus, a part of the dried seaweed (50) on the left side which is in contact with the left guide member 10b is wrapped around the rice ball (40). Note that, the moving distances of the guide members 10b at Steps S3 and S4 may be defined so that one guide member 10b does not touch the other guide member 10b, and here it is set as a half of the given interval. The operations at Steps S1-S4 are repeated until the work is finished (Step S5 in FIG. 5).

Therefore, according to this embodiment, both ends of the dried seaweed (50) are wrapped around the rice ball (40) by operating the two guide members 10b toward the center of the rice ball (40) so that the given interval is reduced. Thus, with a simple configuration, the dried seaweed (50) can be certainly wrapped all around the rice ball (40).

Moreover, in the above embodiment, since the given interval of the two guide members 10b is slightly larger than the width of the rice ball (40), the rice ball (40) is easy to pass through between the two guide members 10b. Thus, the dried seaweed (50) is easy to be wrapped around the rice ball (40).

### First Modification

Note that, although each guide member 10b of the first embodiment is formed in the bar shape, and is configured to horizontally operate toward the center of the rice ball (40), the present disclosure is not limited to this configuration, as long as a part of the guide members operates so that end parts of the dried seaweed (50) are moved toward the center of the rice ball (40).

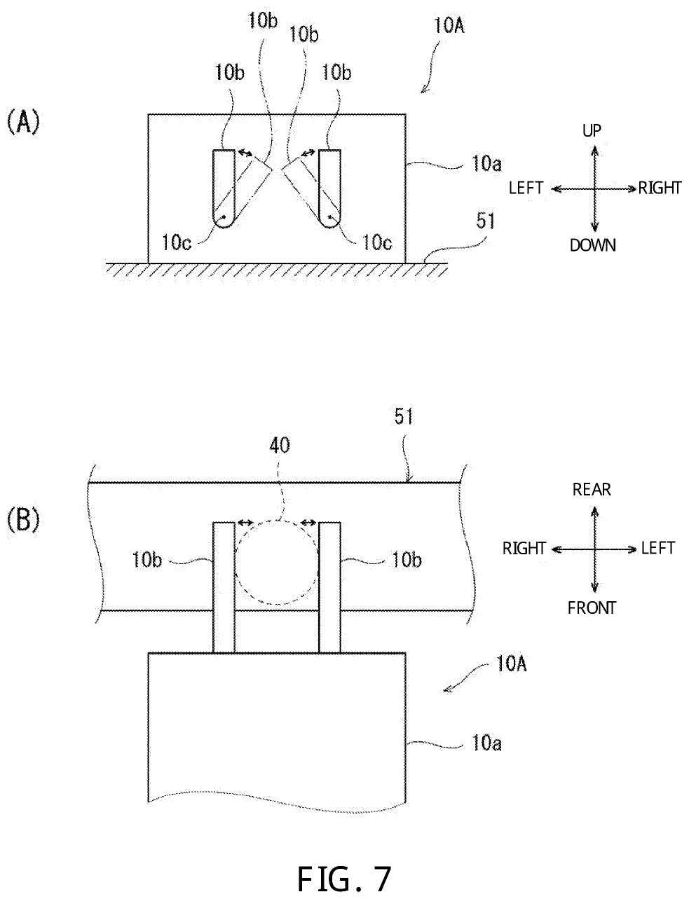

FIG. 7(A) is a front view of the wrapping device main part 10A according to a first modification. FIG. 7(B) is a plan view of the device main part 10A. As illustrated in FIGS. 7(A) and 7(B), this modification differs in that the left and right guide members 10b protrude in a front-and-rear direction, and each has a flat plate shape, as compared with the first embodiment (FIGS. 6(A) to 6(E)). At the reference position, the left and right guide members 10b oppose to each other, and principal surfaces of the flat plates of the guide members 10b are oriented substantially parallel to the vertical direction. Each guide member 10b has a rotation shaft 10c which can be rotated centering on an axis in the front-and-rear direction in a lower part.

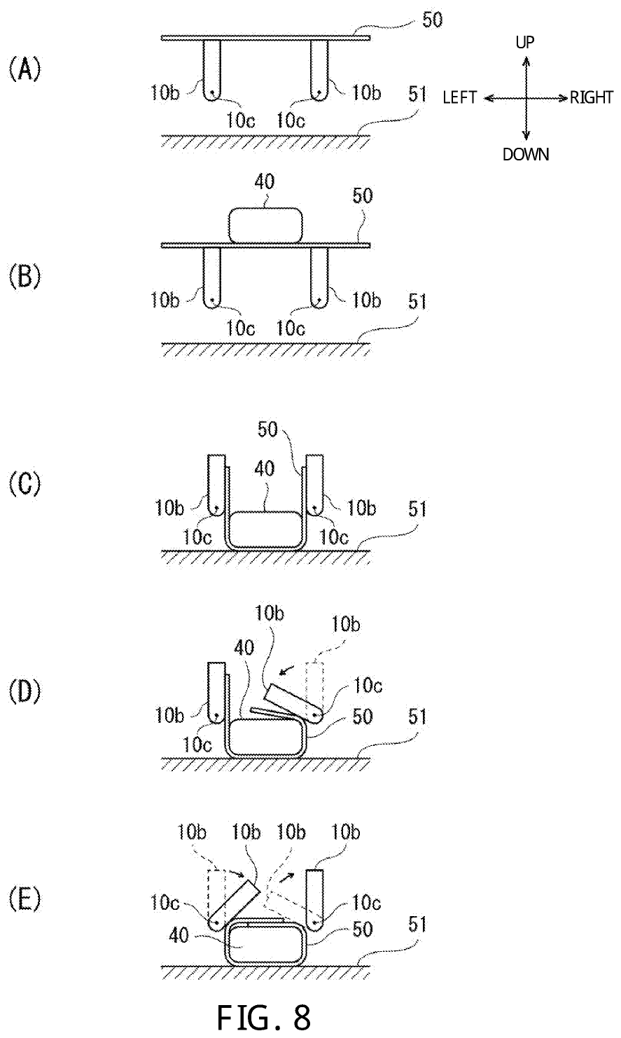

FIGS. 8(A) to 8(E) are schematic views illustrating one example of operation of the wrapping device in FIG. 7. First, as illustrated in FIG. 8(A), the dried seaweed (50) is placed on the two guide members 10b.

Next, as illustrated in FIG. 8(B), the rice ball (40) is disposed on the dried seaweed (50), and at a position between the two guide members 10b. As illustrated in FIG. 8(C), the rice ball (40) placed on the dried seaweed (50) passes through between the two guide members 10b, and falls on the belt conveyor 51 by its own weight.

Next, as illustrated in FIG. 8(D), an upper part of the right guide member 10b moves toward the center of the rice ball (40) from the reference position by a given width, by the rotation of the rotation shaft 10c of the right guide member 10b. Thus, a part of the dried seaweed (50) on the right side which is in contact with the right guide member 10b is wrapped around the rice ball (40).

Next, as illustrated in FIG. 8(E), an upper part of the left guide member 10b moves toward the center of the rice ball (40) from the reference position by the given width, by the rotation of the rotation shaft 10c of the left guide member 10b. Thus, a part of the dried seaweed (50) on the left side which is in contact with the left guide member 10b is wrapped around the rice ball (40).

Thus, also in this modification, the dried seaweed (50) can be certainly wrapped all around the rice ball (40) with a simple configuration, similar to the first embodiment.

### Second Modification

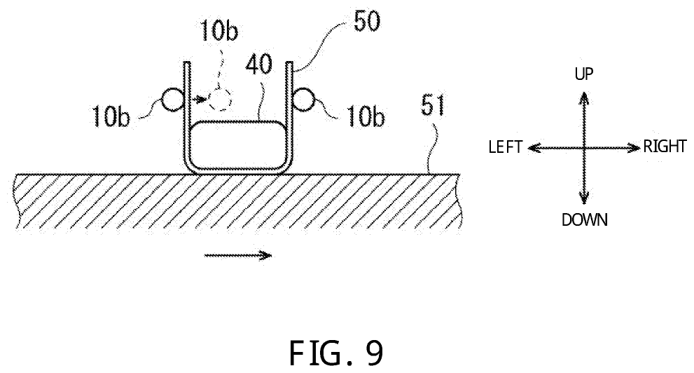

Note that, although in this embodiment the operation of the belt conveyor 51 is suspended during the operation of the wrapping device 1, the present disclosure is not limited to this configuration. FIG. 9 is a schematic view illustrating one example of operation of a wrapping device according to a second modification. As illustrated in FIG. 9, this modification differs in that the right guide member 10b does not operate, but only the left guide member 10b operates in an interlocked manner with the operation of the belt conveyor 51, as compared with the first embodiment (FIGS. 6(A) to 6(E)). Here, since the belt conveyor 51 operates from the left to the right, the rice ball (40) which passed through between the two guide members 10b and fell on the belt conveyor 51 by its own weight is conveyed from the left to the right. Thus, when the rice ball (40) approaches the stationary right guide member 10b, a part of the dried seaweed (50) on the right side which is in contact with the right guide member 10b is wrapped around the rice ball (40).

Next, the control device 14 horizontally moves the left guide member 10b toward the center of the rice ball (40) from the reference position by a given width. Thus, a part of the dried seaweed (50) on the left side which is in contact with the left guide member 10b is wrapped around the rice ball (40).

Thus, according to this modification, the both ends of the dried seaweed (50) can be wrapped around the rice ball (40) only by driving one of the guide members 10b so as to be interlocked with the operation of the belt conveyor 51.

### Second Embodiment

Next, a second embodiment is described. In the following, description of the configuration common to the first embodiment is omitted, and only different configuration is described.

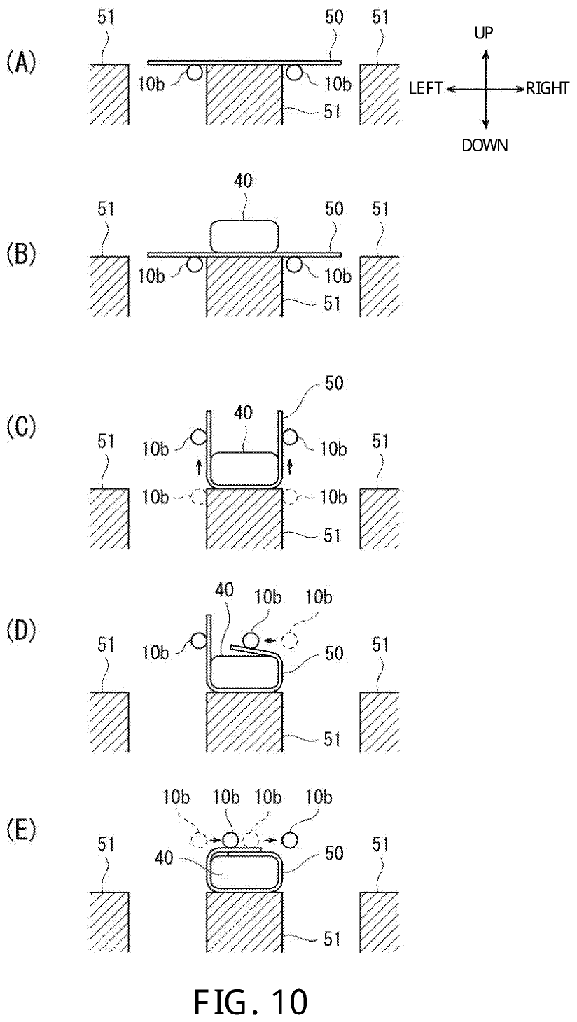

FIG. 10 is a schematic view illustrating one example of operation of the wrapping device according to the second embodiment of the present disclosure. At the reference position, the guide member 10b is located inside a groove formed so as to transverse a conveyance path of the belt conveyor 51, and at the same height as the belt conveyor 51 (refer to FIGS. 10 (A) and 10(B)). This embodiment differs in that the control device 14 controls the operation of the two guide members 10b to move upwardly from the reference positions, while maintaining the given interval, as compared with the first embodiment (FIGS. 6(A) to 6(E)) (refer to FIG. 10(C)). In this embodiment, the two guide members 10b pass both sides of the rice ball 40, instead of the rice ball (40) falling between the two guide members 10b by its own weight. Even with such a configuration, both ends of the dried seaweed (50) can be wrapped around the rice ball (40), similar to the first embodiment (refer to FIGS. 10(D) and 10(E)).

### Other Embodiments

Note that although in the above embodiments the dual-arm type robot 11 feeds the rice ball (40) and the dried seaweed (50), it may be realized by a dedicated device which can hold the rice ball (40) and the dried seaweed (50) and control their positions.

Note that, although in the above embodiments the sheet-like food 50 is the dried seaweed, other examples include meat (meat-wrapped rice ball), an omelet (omelet-wrapped rice ball), a deep-fried tofu (sushi pocket), and kelp (kelp-wrapped rice ball).

Note that, although the food 40 in the above embodiments is the cooked rice molded into the flat cylindrical shape, it is not limited to this shape, and it may be cooked rice molded into a triangular pillar shape. Moreover, instead of the rice, the rice cake made of glutinous rice may be used.

It is apparent for a person skilled in the art that many improvements and other embodiments of the present disclosure are possible from the above description. Therefore, the above description is to be interpreted only as illustration, and it is provided in order to teach a person skilled in the art the best mode that implements the present disclosure. The details of the structures and/or the functions may be changed substantially, without departing from the spirit of the present disclosure.

### INDUSTRIAL APPLICABILITY

The present disclosure is useful for the device which wraps the sheet-like food, such as dried seaweed, around the shaped food.

### DESCRIPTION OF REFERENCE CHARACTERS

1 Wrapping Device
10 Device Main Body
10a Main Body
10b Guide Member
11 Robot
13 Robotic Arm
14 Control Device
18, 19 End Effector
40 Food (Rice Ball)
50 Sheet-like Food (Dried Seaweed)
51 Conveyor

1. A device configured to wrap sheet-like food around shaped food, comprising:
a main body;
two guide members provided at a given interval therebetween so as to protrude from the main body; and
a control part configured to control operation of at least one of the two guide members,
wherein the control part controls operation of the two guide members so that, in a state where the sheet-like food is placed on the two guide members and the food placed on the sheet-like food passes through between the two guide members, a part of at least one of the two guide members moves an end of the sheet-like food toward the center of the food to wrap the end of the sheet-like food around the food.

2. The wrapping device of claim 1, wherein the control part controls the two guide members to move toward the center of the food so that the given interval is reduced.

3. The wrapping device of claim 1, wherein the food passes through between the two guide members by the sheet-like food being placed on the two guide members, and the food placed on the sheet-like food falling between the two guide members by the own weight of the food.

4. The wrapping device of claim 1, wherein the control part controls operation of the two guide members to move upwardly while maintaining the given interval so that the sheet-like food is placed on the two guide members, and the two guide members pass through both sides of the food disposed on the sheet-like food.

5. The wrapping device of claim 1, wherein the given interval is slightly larger than a width of the food.

6. The wrapping device of claim 1, further comprising a robot including:
a base;
a first robotic arm coupled to the base and configured to feed the sheet-like food to a given position; and
a second robotic arm coupled to the base and configured to feed a shaped food to a given position,
wherein the first robotic arm places the sheet-like food on the two guide members, and
wherein the second robotic arm places the food on the sheet-like food, and at a position between the two guide members.

7. A method of wrapping sheet-like food around shaped food by a wrapping device for the sheet-like food including a main body, two guide members provided at a given interval therebetween so as to protrude from the main body, and a control part configured to control at least one of the two guide members,
wherein the control part controls operation of the two guide members so that, in a state where the sheet-like food is placed on the two guide members and the food placed on the sheet-like food passes through between the two guide members, a part of at least one of the two guide members moves an end of the sheet-like food toward the center of the food to wrap the end of the sheet-like food around the food.

8. The wrapping device of claim 2, wherein the given interval is slightly larger than a width of the food.

9. The wrapping device of claim 3, wherein the given interval is slightly larger than a width of the food.

10. The wrapping device of claim 4, wherein the given interval is slightly larger than a width of the food.

11. The wrapping device of claim 2, further comprising a robot including:
a base;
a first robotic arm coupled to the base and configured to feed the sheet-like food to a given position; and
a second robotic arm coupled to the base and configured to feed a shaped food to a given position,
wherein the first robotic arm places the sheet-like food on the two guide members, and
wherein the second robotic arm places the food on the sheet-like food, and at a position between the two guide members.

12. The wrapping device of claim 2, further comprising a robot including:
a base;
a first robotic arm coupled to the base and configured to feed the sheet-like food to a given position; and
a second robotic arm coupled to the base and configured to feed a shaped food to a given position,
wherein the first robotic arm places the sheet-like food on the two guide members, and
wherein the second robotic arm places the food on the sheet-like food, and at a position between the two guide members.

13. The wrapping device of claim 3, further comprising a robot including:
a base;
a first robotic arm coupled to the base and configured to feed the sheet-like food to a given position; and
a second robotic arm coupled to the base and configured to feed a shaped food to a given position,
wherein the first robotic arm places the sheet-like food on the two guide members, and
wherein the second robotic arm places the food on the sheet-like food, and at a position between the two guide members.

14. The wrapping device of claim 4, further comprising a robot including:
a base;
a first robotic arm coupled to the base and configured to feed the sheet-like food to a given position; and
a second robotic arm coupled to the base and configured to feed a shaped food to a given position,
wherein the first robotic arm places the sheet-like food on the two guide members, and
wherein the second robotic arm places the food on the sheet-like food, and at a position between the two guide members.
